(19) United States
(12) Patent Application Publication
(10) Pub. No.: US 2013/0329656 A1
(43) Pub. Date: Dec. 12, 2013

(54) COMMON ORDERS FOR A SHARED CONTROL CHANNEL

(71) Applicant: Telefonaktiebolaget LM Ericsson (publ), Stockholm (SE)

(72) Inventors: Bo GÖRANSSON, Sollentuna (SE); Johan Bergman, Stockholm (SE); Johan Hultell, Solna (SE); Sairamesh Nammi, Stockholm (SE)

(73) Assignee: Telefonaktiebolaget LM Ericsson (publ), Stockholm (SE)

(21) Appl. No.: 13/898,119

(22) Filed: May 20, 2013

Related U.S. Application Data
(60) Provisional application No. 61/651,203, filed on May 24, 2012.

(51) Int. Cl. H04W 76/04

(52) U.S. Cl. CPC H04W 76/046
USPC 370/329

(57) ABSTRACT

A radio base station communicates with UEs on a shared control channel in a cell coverage area. A common control channel order, for transmission over the shared control channel for a group of multiple UEs in the cell, is associated with a common control channel order identifier and transmitted in the cell over the shared control channel. A UE in a shared cell coverage area receives and processes the common control channel order signal transmitted to the group of multiple UEs to detect the common control channel signal identifier. If the UE determines that common control channel signal identifier matches a common control channel signal identifier previously configured for or stored in each of the UEs in the group, then the UE processes the common control channel order and performs one or more actions in response to the processed common control channel order.

### PRIORITY APPLICATION

This application claims priority from U.S. provisional patent application 61/651,203, filed on May 24, 2012, the contents of which are incorporated herein by reference.

### TECHNICAL FIELD

The technology relates to radio communications, and in particular, to sending control signals to user equipments (UEs).

### BACKGROUND

The technology in this application is described in a non-limiting example Universal Terrestrial Radio Access Network (UTRAN)/Wideband Code Division Multiple Access (WCDMA) context. A UTRAN type of system such as the example illustrated in FIG. 1. The radio network controller (RNC) communicates with one or more core network (CN) nodes which are connected to one or more other networks, e.g., the Internet, public and private telephone networks, etc. The RNC also communicates with one or more base stations called Node B's as well as one or more other RNCs. Each Node B communications over a radio interface Uu with one or more user equipments (UEs). WCDMA has been upgraded to include high speed packet access (HSPA) in two steps. The first step improved the downlink by introducing high speed downlink packet access (HSDPA), which is based on shared channel transmission, and includes features such as shared channel and multi-code transmission, higher-order modulation, short Transmission Time Interval (TTI), fast link adaptation and scheduling along with fast Hybrid Automatic Repeat reQuest (HARQ). The second step improved the uplink by introducing high speed uplink packet access (HSUPA). HSDPA includes a transport layer channel, a High-Speed Downlink Shared Channel (HS-DSCH), implemented using three physical layer channels. The High Speed-Shared Control Channel (HS-SCCH) informs a UE that data will be sent on the HS-DSCH, two slots ahead of time. The Uplink High Speed-Dedicated Physical Control Channel (HS-DPCCH) carries acknowledgment information and a current channel quality indicator (CQI) of the UE. This value is then used by the base station to calculate how much data to send to UEs on the next transmission. The High Speed-Physical Downlink Shared Channel (HS-PDSCH) is the channel mapped to the HS-DSCH transport channel that carries actual user data.

HS-SCCH orders are used in HSPA as a fast layer L1/L2 control signaling that complements slower, higher protocol layer signaling such as radio resource control (RRC) signaling. Examples of HS-SCCH orders relate to (de)activation or triggering and include: UE discontinuous transmission (DTX) (de)activation (HS-SCCH orders introduced in the 3GPP HSPA standard Release-7), UE discontinuous reception (DRX) (de)activation (orders introduced in Rel-7), HS-SCCH-less operation (de)activation (orders introduced in Rel-8), enhanced serving cell change triggering (orders introduced in Rel-8), secondary downlink carrier (de)activation in multiple carrier (MC)-HSDPA (orders introduced in Rel-8, Rel-9, Rel-10 and Rel-11), secondary uplink carrier (de)activation in DC-HSUPA (orders introduced in Rel-9), and switching between uplink (UL) transmit diversity activation states (orders introduced in Rel-11). See section 4.6C in 3GPP TS 25.212, Multiplexing and channel coding (FDD) (Release 11), V11.0.0 (2011-12) and sections 6A.1, 6B, 6C.4 and 10.5 in 3GPP TS 25.214, Physical layer procedures (FDD) (Release 11), V11.0.0 (2011-12) for further details.

New HS-SCCH orders are being considered within the ongoing Rel-11 work item “Further Enhancments to CELL_FACH” (3GPP Tdoc R1-111336). New HS-SCCH orders may also be considered within other ongoing Rel-11 work items such as “Four Branch MIMO Transmission for HSDPA” (3GPP Tdoc RP-111393), “HSDPA Multiflow Data Transmission” (3GPP Tdoc RP-111375), and “MIMO with 64QAM for HSUPA” (3GPP Tdoc RP-111642). For example, in the Rel-11 work item “Four Branch MIMO Transmission for HSDPA,” the intention is to introduce scheduled demodulation pilots, where a Node B can dynamically turn on or off the transmission of the demodulation pilots for specific antennas based on, e.g., radio conditions, traffic conditions, user locations, etc. The timing of when these pilot signals are turned on or off may be indicated to the UE via an HS-SCCH order.

With increasing packet data usage, e.g., in the form of smartphone traffic, mobile broadband traffic, and machine type communications, the number of HSPA connections that need to be handled simultaneously is increasing. In addition, the HSPA standard releases since Rel-7 has introduced new features that make use of HS-SCCH orders. As network requirements, e.g., in terms of coverage, capacity, cost, and energy efficiency, increase, so does the need to ensure that various features are operated in an efficient mode or activation state. These trends point to an increased need for the NodeB to make use of HS-SCCH orders, and therefore, there is a need to ensure that HS-SCCH orders can be transmitted efficiently.

One problem with current HS-SCCH orders is that an HS-SCCH order only can be sent to one UE at a time, i.e., an HS-SCCH order is dedicated to one UE. Accordingly, changing the activation states for many UEs means that many HS-SCCH orders must be sent that require significant radio and processing resources and also create interference.

### SUMMARY

In example embodiments, a radio base station that communicates with user equipments (UEs) over a radio interface on a shared control channel in a cell coverage area determines a common control channel order for transmission over the shared control channel for a group of multiple UEs in the cell. The base station processes the common control channel order to associate the common control channel order with a common control channel order identifier and transmits the processed common control channel order in the cell over the shared control channel.

A non-limiting example of the processing includes masking the common control channel order to associate the common control channel order with the common control channel order identifier.

In one example implementation, the base station monitors for common control channel order acknowledgment messages (ACKs) from the UEs in the group. When an ACK is not received from one of the UEs in the group, the base station retransmits the processed common control channel order using a dedicated control channel order that includes a UE-specific identifier assigned to the one UE that is not assigned to the other UEs in the group. In one example implementation, when an ACK is not received from one of the UEs in the group, the base station determines if a total number of ACKs received from UEs in the group is less than a threshold. If so, the base station retransmits the processed common control channel order, and if not, the base station transmits the common control channel order using a dedicated control channel order that includes a UE-specific identifier assigned to the one UE that is not assigned to the other UEs in the group.

In another example implementation, the base station determines a dedicated, UE-specific control channel order for the shared control channel for one or more of the UEs that is different from the common control channel order. The dedicated, UE-specific control channel order is processed to associate the dedicated, UE-specific control channel order with a corresponding dedicated, UE-specific control channel order identifier. The base station transmits the processed dedicated, UE-specific control channel order in the cell. The base station and UEs, for example, may be part of a high speed packet access (HSPA) cellular communications system that includes a radio network controller (RNC) communicating with the base station, where the shared control channel is a high speed shared control channel (HS-SCCH), the common control channel order identifier is a common high speed downlink shared channel (HS-DSCH) Radio Network Identifier (H-RNTI), and the dedicated, UE-specific control channel order identifier is a dedicated, UE-specific H-RNTI. In this example, the base station may receive from the RNC a common H-RNTI and a dedicated, UE-specific H-RNTI for each UE in the group, where each respective dedicated, UE-specific H-RNTI is different. The base station then sends the common H-RNTI to the group of UEs and each dedicated, UE-specific H-RNTI to each respective UE.

In example embodiments, a UE that communicates with a radio base station over a radio interface on a shared control channel in a cell coverage area that is shared by multiple UEs receives a common control channel order signal transmitted by the base station in the cell to a group of multiple UEs over the shared control channel. The UE processes the common control channel order signal and detects a common control channel signal identifier associated with the common control channel order signal. If the UE determines that common control channel signal identifier matches a common control channel signal identifier previously configured for or stored in each of the UEs in the group, then the UE processes the common control channel order and performs one or more actions in response to the processed common control channel order.

In one example implementation, the UE receives a dedicated control channel order signal specific to the UE transmitted by the base station in the cell over the shared control channel and detects a dedicated control channel signal identifier specific to the UE associated with the dedicated, UE-specific control channel order signal. The UE then performs one or more actions in response to the processed, dedicated, UE-specific control channel order. As a further more specific example where the base station and UE are part of a high speed packet access (HSPA) cellular communications system that includes a radio network controller (RNC) communicating with the base station, the shared control channel is a high speed shared control channel (HS-SCCH), the common control channel order identifier is a common high speed downlink shared channel (HS-DSCH) Radio Network Identifier (H-RNTI), and the dedicated, UE-specific control channel order identifier is a dedicated, UE-specific H-RNTI, the UE receives from the RNC via the base station a common H-RNTI and a dedicated, UE-specific H-RNTI.

In example embodiments, a radio network controller (RNC) in communication with a base station generates a common control channel order identifier for use by the base station in transmitting a common control channel order over the shared control channel to a group of multiple UEs in the cell. The RNC sends the common control channel order identifier to the base station, wherein the base station is configured to send the common control channel order identifier to each of the UEs in the group.

In one example implementation, the RNC generates a dedicated, UE-specific control channel identifier for the shared control channel each of one or more of the UEs in the group. Each dedicated, UE-specific control channel identifier is different from the other dedicated, UE-specific control channel identifiers and from the common control channel identifier. The RNC sends the dedicated, UE-specific control channel identifiers to the base station for use by the base station and distribution by the base station to corresponding UEs in the group. As a further more specific example, the RNC, base station, and UEs are part of a high speed packet access (HSPA) cellular communications system, the shared control channel is a high speed shared control channel (HS-SCCH), the common control channel order identifier is a common high speed downlink shared channel (HS-DSCH) Radio Network Identifier (H-RNTI), and the dedicated, UE-specific control channel order identifier is a dedicated, UE-specific H-RNTI.

### BRIEF DESCRIPTION OF THE DRAWINGS

FIG. 1 is a diagram of a non-limiting example Universal Terrestrial Radio Access Network (UTRAN)/Wideband Code Division Multiple Access (WCDMA) system.

FIG. 2 shows a base station transmitting a common HS-SCCH order to a group of two UEs in a cell served by the base station.

FIG. 3 is a flowchart diagram illustrating example procedures that may be performed by a radio network controller (RNC).

FIG. 4 is a flowchart diagram illustrating example procedures that may be performed by a Node B or base station more generally.

FIG. 5 is a flowchart diagram illustrating example procedures that may be performed by a UE.

FIG. 6 shows an example, non-limiting HS-SCCH slot format useable in an HSPA type system.

FIG. 7 shows an example, non-limiting encoding process for the Part I message of a Type 4 HS-SCCH slot.

FIG. 8 shows an example, non-limiting encoding process for the Part 2 message of a Type 4 HS-SCCH slot.

FIGS. 9 and 10 are flowchart diagrams illustrating example procedures where the network monitors HARQ-ACKs from all UEs in the group and, if one or several UEs do not ACK the order, how the network either retransmits the order using a common order or retransmits the order only to users that have not ACKed the order, respectively.

FIG. 11 shows non-limiting, example function block diagrams of multiple UEs 20 and a base station/NodeB 10 that may be used to implement the technology described above.

FIG. 12 is a function block diagram of an example computer implementation of the machine platform 30 realized by or implemented as one or more computer processors or controllers and which may execute instructions stored on a non-transitory, computer-readable storage medium.

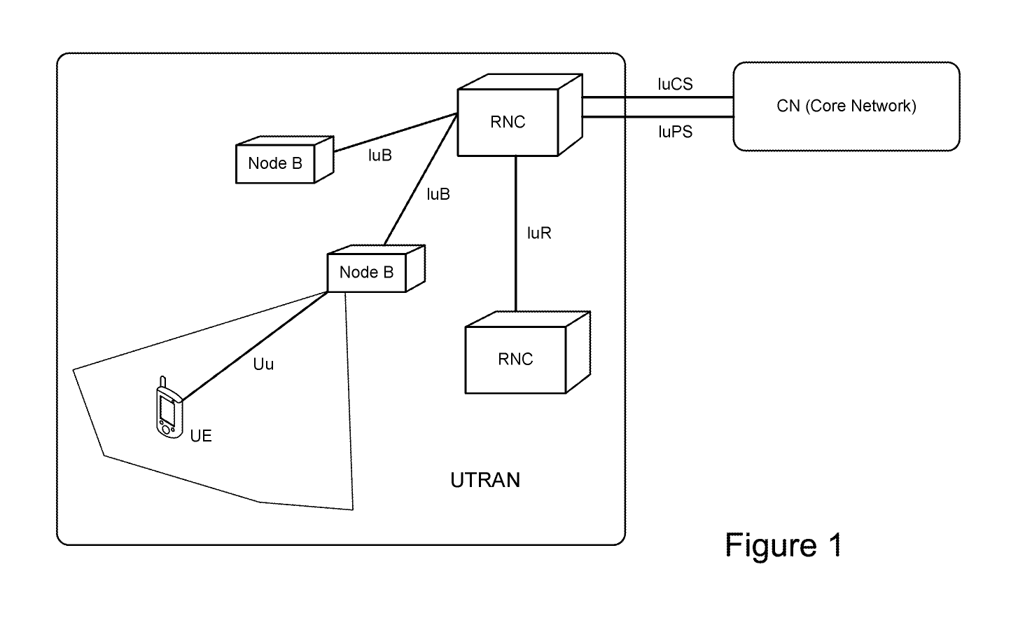

### DESCRIPTION OF NON-LIMITING EXAMPLE EMBODIMENTS

The following sets forth specific details, such as particular embodiments for purposes of explanation and not limitation. But it will be appreciated by one skilled in the art that other embodiments may be employed apart from these specific details. In some instances, detailed descriptions of well known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

Although the description is given for user equipment (UE), it should be understood by the skilled in the art that “UE” is a non-limiting term comprising any wireless device or node equipped with a radio interface allowing for at least one of: transmitting signals in the uplink (UL) and receiving and/or measuring signals in the downlink (DL). Some examples of UE in its general sense are PDA, laptop, mobile, sensor, fixed relay, mobile relay, a radio network node (e.g., an LMU or a femto base station or a small base station using the terminal technology). A UE herein may comprise a UE (in its general sense) capable of operating or at least performing measurements in one or more frequencies, carrier frequencies, component carriers or frequency bands. It may be a “UE” operating in single- or multi-RAT or multi-standard mode.

A cell is associated with a base station, where a base station comprises in a general sense any node transmitting radio signals in the downlink (DL) and/or receiving radio signals in the uplink (UL). Some example base stations are eNodeB, eNB, Node B, macro/micro/pico radio base station, home eNodeB, relay, repeater, sensor, transmitting-only radio nodes or receiving-only radio nodes. A base station may operate or at least perform measurements in one or more frequencies, carrier frequencies or frequency bands and may be capable of carrier aggregation. It may also be a single-radio access technology (RAT), muti-RAT, or multi-standard node, e.g., using the same or different base band modules for different RATs.

The example embodiments are described in the non-limiting example context of a UTRAN HSPA type system. However, the technology is not limited to UTRAN, but may apply to any suitable Radio Access Network (RAN), single-RAT or multi-RAT.

Many UEs in a cell share a shared control channel such as but not limited to the HS-SCCH in HSPA. An order may be sent to a specific individual UE over the shared control channel by including a dedicated UE identifier for that UE in the order. That way only that one UE responds to the order and all the other UEs sharing the control channel ignore it. The inventors in this application recognized the need and desirability of a common shared control channel order (referred to hereafter as a “common control channel order”) that is provided to address multiple UEs in a cell. In the following description, a non-limiting example, common control channel order is a common HS-SCCH order that allows a single HS-SCCH order to address multiple UEs in a cell. The common control channel order provides a way to send a control command to many UEs without sending multiple different HS-SCCH orders dedicated to individual UEs. To achieve this, a new type of UE identity is introduced. A common control channel UE identity may be used to signal information to multiple UEs using one common control channel order, e.g., one HS-SCCH order. This common control channel UE identity is the same or common for a group of multiple UEs in a cell including but not necessarily all UEs in the cell. The grouping of UEs may be based on one or more factors, e.g., UE capabilit(ies). This common control channel UE identity for a group of UEs may be conveyed to those UEs (and to Node Bs), for example, via higher layer (e.g., RRC) signaling from the RNC. As a result, a UE may have multiple, different UE identities when it comes to common control channel orders like HS-SCCH orders.

In the non-limiting examples below, a common control channel UE identity is introduced called a common HS-DSCH Radio Network Identifier (H-RNTI). This common H-RNTI is different from a dedicated HS-DSCH Radio Network Identifier (H-RNTI) which is dedicated to one UE. For the remaining description, a common HS-SCCH order and a common H-RNTI are used for illustration only and not limitation. By using the same common H-RNTI for multiple UEs, a common HS-SCCH order may be defined. A single common HS-SCCH order addresses multiple UEs thereby eliminating the need to send multiple dedicated HS-SCCH orders, although dedicated HS-SCCH orders may still be used where appropriate. In other words, the network and UEs may be configured to receive and respond to both dedicated, UE-specific HS-SCCH orders and common HS-SCCH orders.

The network, e.g., by an RNC node via a Node B or other type of base station including low power base stations or by a base station directly, may inform the UE of one or more configurations of common control channel orders associated with the nodes associated with the coverage area, e.g., through higher layer signaling. Non-limiting examples of such nodes include macro, pico, femto, remote radio unit, WiFi, or other type radio node. For example, at the time of cell setup, the network may configure a common H-RNTI of a desired cell and may also configure a list of common H-RNTIs of the neighboring cells through RRC signaling. Other ways of communicating common control channel UE identify information may also be used.

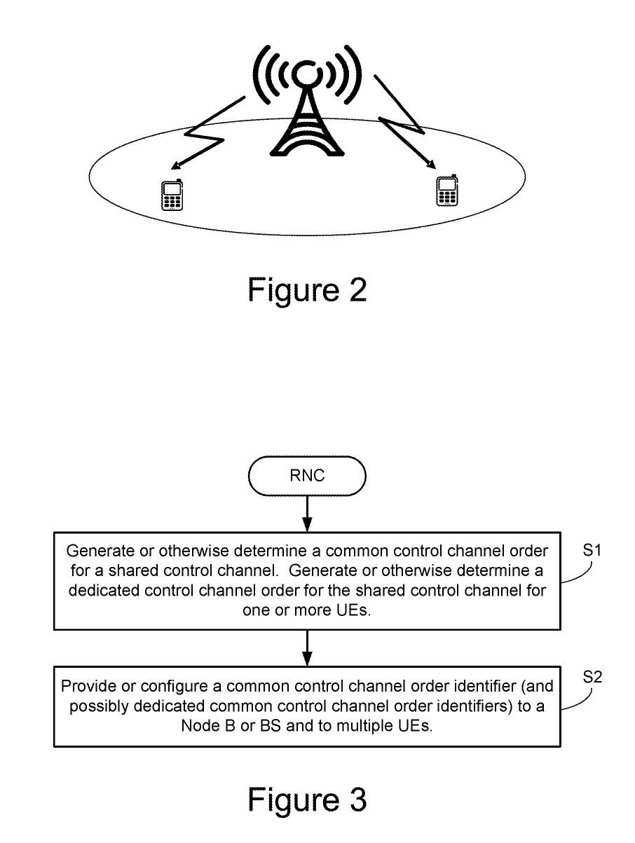

FIG. 2 shows a base station transmitting a common HS-SCCH order to a group of two UEs in a cell served by the base station. The common HS-SCCH order, in this non-limiting HSPA example, is scrambled with the cell's specific downlink scrambling code as outlined in existing 3GPP specifications. This means that in this example embodiment, common HS-SCCH orders from a particular cell belonging to a particular base station, e.g., a NodeB, only affect UEs monitoring HS-SCCH channels (e.g., using HS-SCCH channelization codes) in that cell. In existing 3GPP specifications, the UEs monitor a number of HS-SCCH channels in the serving HS-DSCH cell, in any activated secondary serving HS-DSCH cells, and up to one HS-SCCH channel in one or more non-serving neighbor cells (for triggering of enhanced serving cell change). Each cell has a corresponding primary scrambling code which UEs may use to differentiate between HS-SCCH channels.

FIG. 3 is a flowchart diagram illustrating example procedures that may be performed by a radio network controller (RNC). The RNC generates or otherwise determines a common control channel order for a shared control channel (step S1). The RNC may also generate or otherwise determine a dedicated control channel order for the shared control channel for one or more UEs. In the next step, the RNC provides or configures a common control order identifier (and possibly dedicated common control channel order identifiers) to a Node B or base station and to multiple UEs (step S2).

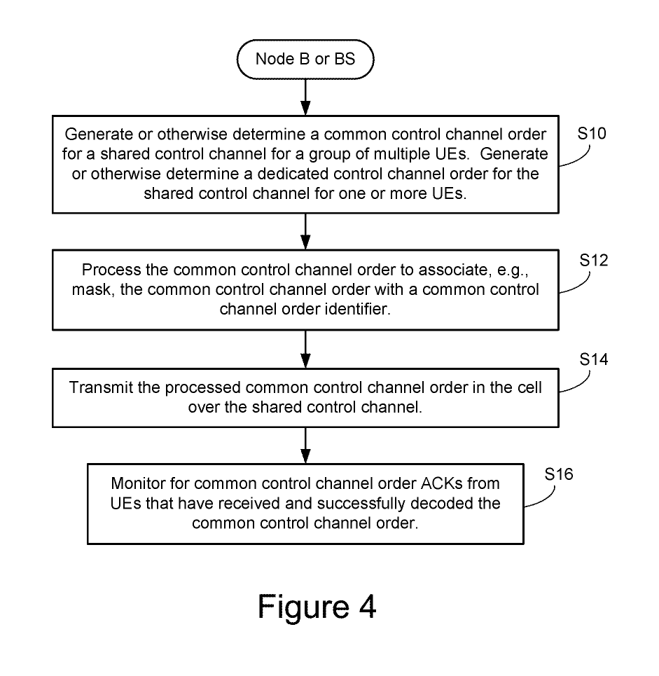

FIG. 4 is a flowchart diagram illustrating example procedures that may be performed by a Node B or base station more generally. The base station generates or otherwise determines a common control channel order for a shared control channel for a group of multiple UEs (step S10). The base station may also generate or otherwise determine a dedicated control channel order for the shared control channel for one or more UEs (step S10). Thereafter, the base station processes the common control channel order to associate, e.g., mask, the common control channel order with a common control channel order identifier (step S12), and later transmits the processed common control channel order in the cell over the shared control channel (step S14). Optionally, the base station monitor for common control channel order ACKs from UEs that have received and successfully decoded the common control channel order (step S16). This option is described in further detail below.

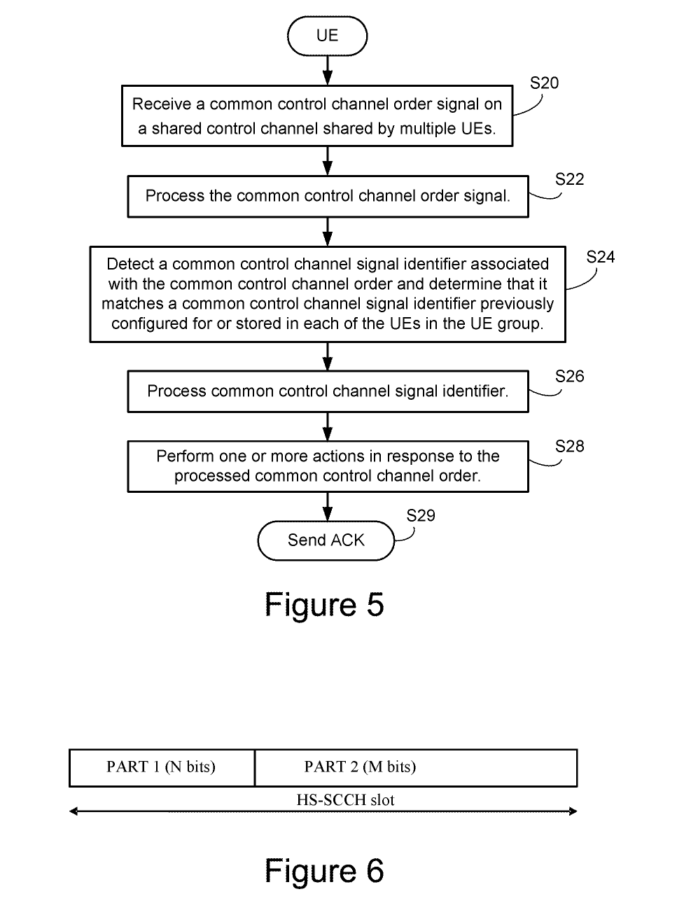

FIG. 5 is a flowchart diagram illustrating example procedures that may be performed by a UE. In step S20, the UE receives a common control channel order signal on a shared control channel shared by multiple UEs and processes a cell's common control channel signal shared by multiple UEs. The UE processes the common control channel order signal in step S22. The UE detects a common control channel signal identifier associated with the common control channel order and determines that it matches a common control channel signal identifier previously configured for or stored in each of the UEs in the UE group (step S24). The UE then processes the common control channel signal identifier in step S26, and performs one or more actions in response to the processed common control channel order in step S28. The UE in some example embodiments may send an ACK in step S29.

FIG. 6 shows an example, non-limiting HS-SCCH slot format useable in an HSPA type system. Part 1 of the HS-SCCH slot carries information related to a channelization code set, precoding weight information, modulation scheme and number of transport blocks preferred. Part 2 of the HS-SCCH slot carries information on transport block size, HARQ process, and redundancy and constellation version. Based on the number of bits N in Part 1, and number of bits M in Part 2 of the HS-SCCH slot, HS-SCCHs are divided in to 4 types: Type 1-Applicable for single antenna communication—3GPP HSPA Release 5, Type 2-Applicable when the UE is operating in HS-SCCH less mode, Type 3-Applicable when the UE is configured in MIMO mode—3GPP HSPA Release 7, and Type 4-Applicable when the UE is configured in MIMO mode with four transmit antennas—3GPP HSPA Release 11. In addition, based on a bit identity in Part 1, the HS-SCCH slot can be an HS-SCCH order or the actual signal.

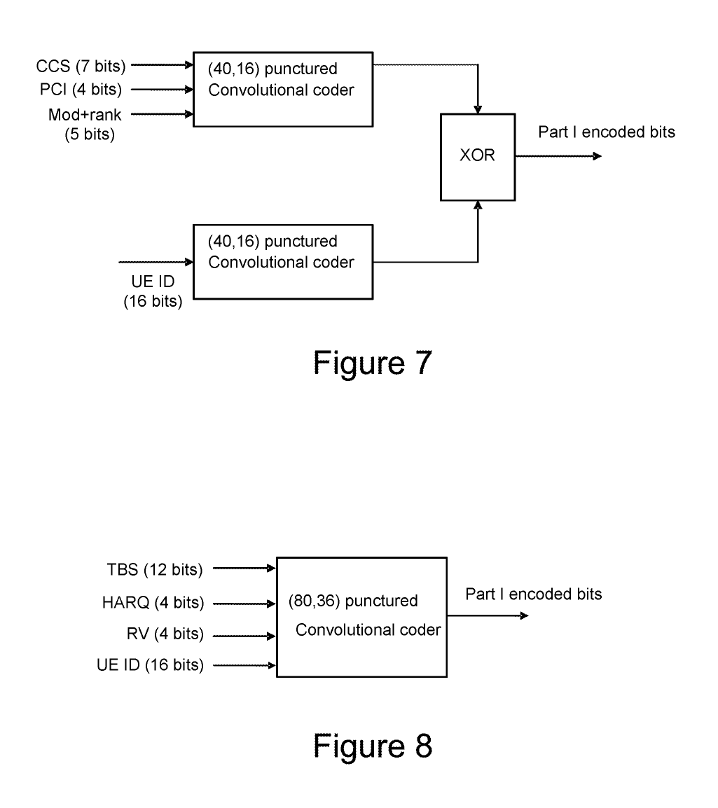

FIG. 7 shows an example, non-limiting encoding process for the Part I message of a Type 4 HS-SCCH slot. First, modulation index/rank information (5 bits), code allocation (CCS 7 bits), and precoding weight information (PCI 4 bits) are encoded by a (40,16) punctured convolutional coder in this example. These encoded bits are bit-masked using, for example, an XOR or similar operation with a UE-specific sequence which is generated by encoding a 16-bit UE ID using a (40, 16) punctured convolutional code. The 16-bit UE ID corresponds in this example to a HS-DSCH Radio Network Identifier (H-RNTI), which can either be a common H-RNTI or a dedicated H-RNTI. These 40 Part I encoded bits are spread by spreading factor 128, QPSK-modulated, and transmitted in one slot. The dedicated H-RNTI may be configured by the RNC for this particular UE.

FIG. 8 shows an example, non-limiting encoding process for the Part 2 message of a Type 4 HS-SCCH slot. The transport block size (TBS-12 bits) for the transport blocks, HARQ process identifiers (4 bits), redundancy versions (RV-4 bits), and the UE id (H-RNTI-16 bits) are sent through a punctured convolutional encoder. The 80 output bits are spread by spreading factor 128, QPSK modulated, and transmitted in two slots.

For a UE to decode common HS-SCCH orders, including both Parts 1 and 2, the UE must be addressed by a common UE-identifier, which in this non-limiting example is a common H-RNTI. For a UE to decode a dedicated HS-SCCH order, the UE must be addressed by a dedicated UE-identifier, which in this non-limiting example is a dedicated H-RNTI.

Accordingly, an RNC may send two H-RNTIs to a UE, e.g., using RRC signaling, during the RRC configuration/re-configuration. One H-RNTI is for dedicated UE signaling and the other for common signaling. The Node B masks the HS-SCCH order or signal with the appropriate H-RNTI based on the type of HS-SCCH order or signal. For example, if the HS-SCCH signal is dedicated to a particular UE, the Node B masks the HS-SCCH signal with a dedicated H-RNTI as illustrated in FIGS. 7 and 8. If the HS-SCCH signal is a common HS-SCCH signal, then the Node B masks the HS-SCCH signal with a common H-RNTI. The UE first detects Part 1 of a received HS-SCCH signal and then Part 2. Since the UE does not have information as to whether the HS-SCCH signal is common or dedicated, the UE decodes, either sequentially or in parallel, the received HS-SCCH signal with the two HS-RNTIs. Once the cyclic redundancy check (CRC) is passed for both the parts of the decoded HS-SCCH signal, i.e., a successful decoding by the UE, the UE can identify whether the HS-SCCH signal is a dedicated order/signal or a common HS-SCCH order.

The following simple 3-bit example illustrates the masking operation. Assume that the common order corresponds to an input codeword x=[1 0 1] and that H is the common control channel UE id, where H=[1 1 1]. In other words, the common control channel UE id is a common H-RNTI. The masked signal z that is transmitted signal is z=XOR (x,H)=[0 1 0]. Upon reception at the UE, the UE performs its own masking using an XOR operation with its common control channel UE id to determine the received information: x_rec=XOR (z,H)=[1 0 1], which is an accurate reconstruction of input codeword x=[1 0 1].

Other example embodiments include some form of acknowledgement of common control channel orders. A dedicated, UE-specific HS-SCCH order (except for the order used for triggering enhanced serving cell change), may be acknowledged by the UE with an ACK codeword in the HARQ-ACK field on the HS-DPCCH channel. While the HS-SCCH is a downlink control channel, the HS-DPCCH is an uplink control channel that conveys channel state information to the Node B. The UE does not send a NACK in response to a dedicated HS-SCCH order. If the UE does not ACK the dedicated HS-SCCH order, then the NodeB may choose to retransmit the dedicated HS-SCCH order, possibly with a higher transmit power, until an ACK is received from the UE (or until a maximum number of retransmissions is reached).

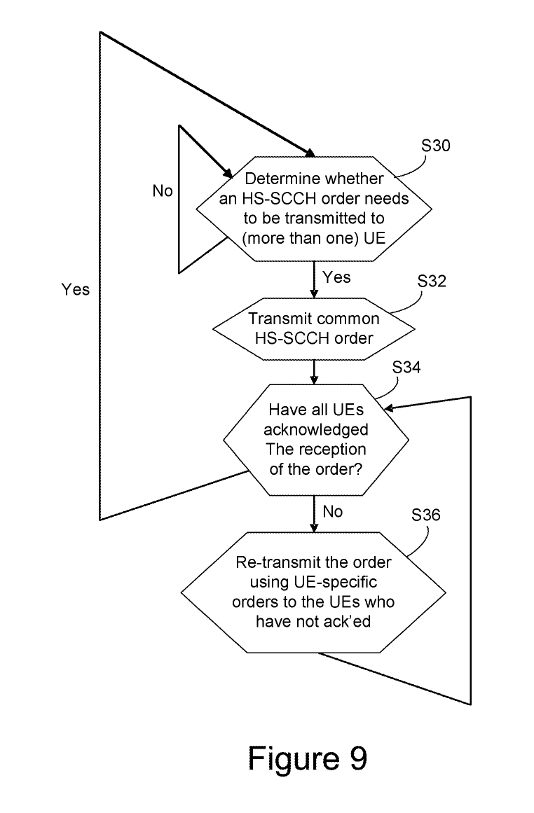

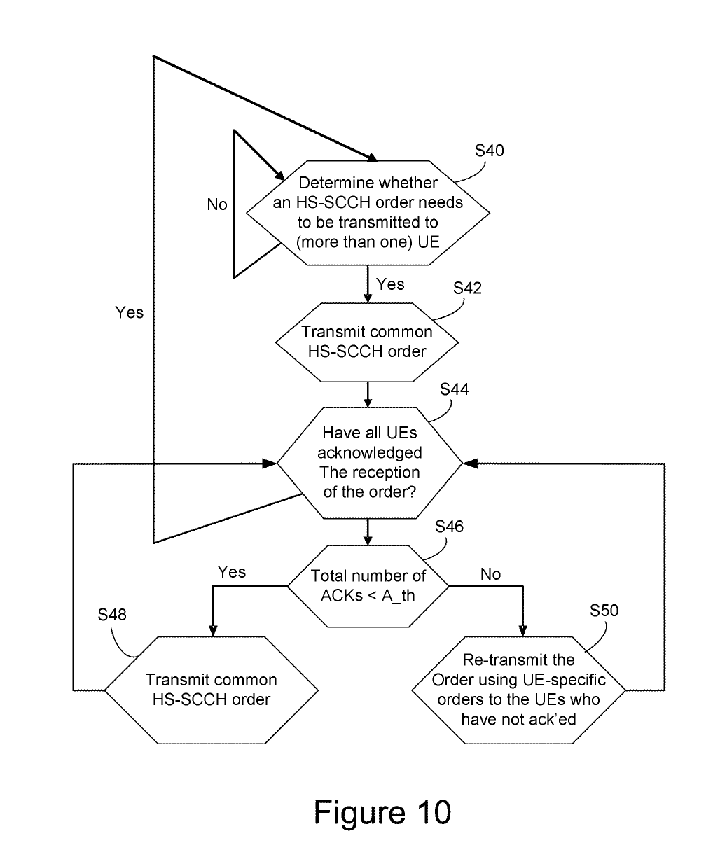

For common HS-SCCH orders, the network may monitor HARQ-ACKs from all UEs in the group. If one or several UEs do not ACK the order, then the network may choose to either retransmit the order using a common order or retransmit the order only to users that have not ACKed the order. These example embodiments are outlined in the flow charts shown in FIGS. 9 and 10.

For FIG. 9, starting at step S30, the base station determines whether an HS-SCCH order needs to be transmitted to more than one UE. If so, the base station transmits a common HS-SCCH order (step S32). A decision is made in step S34 whether all UEs have acknowledged reception of the common order. If not, the base station may retransmit the HS-SCCH order using you UE-specific or dedicated HS-SCCH orders to the UEs that have not acknowledged (step S36).

In FIG. 10, starting at step S40, the base station determines whether an HS-SCCH order needs to be transmitted to more than one UE. If so, the base station transmits a common HS-SCCH order (step S42). A decision is made in step S44 whether all UEs have acknowledged reception of the common order. If not, a further decision is made whether a total number of ACKs is less than A_th, which is a pre-configured threshold. This allows the base station to determine whether the common HS-SCCH order should be retransmitted as a common HS-SCCH order to all the UEs (step S48) or as UE-specific, dedicated HS-SCCH orders to the UEs from which NodeB did not receive ACKs for the common HS-SCCH order (step S50).

Each UE can, in the general case, only transmit either one ACK or one NACK (or not transmit anything at all, i.e., DTX) in the HARQ-ACK field on HS-DPCCH at a given point in time. Accordingly, it is difficult for the UE to acknowledge both a dedicated HS-SCCH order and a common HS-SCCH order at the same time. The NodeB can avoid potential ambiguities by avoiding transmitting UE-specific and common HS-SCCH orders simultaneously to a UE.

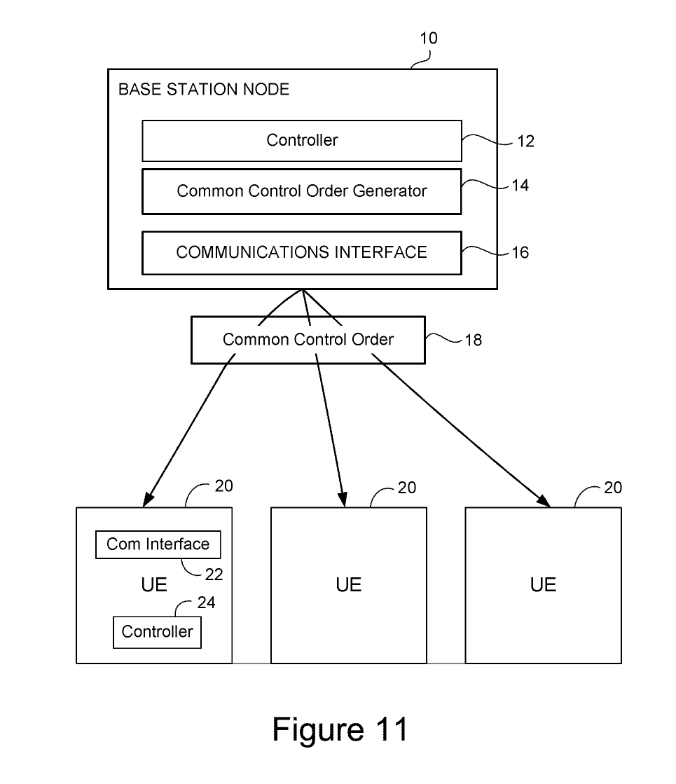

FIG. 11 shows non-limiting, example function block diagrams of multiple UEs 20 and a base station/NodeB 10 that may be used to implement the technology described above. The base station 10 includes a controller 12 and common control channel order generator 14 that may be implemented using one or more data processors coupled to communications interface circuitry 16 including radio communications circuitry and circuitry for communicating with other radio and/or core network nodes such as an RNC. A common control channel order 18 is shown being transmitted and received by three UEs 20 in a particular group. Each UE 20 may include a communications interface 22, including suitable radio communications circuitry, a controller 24, and user interface (not shown).

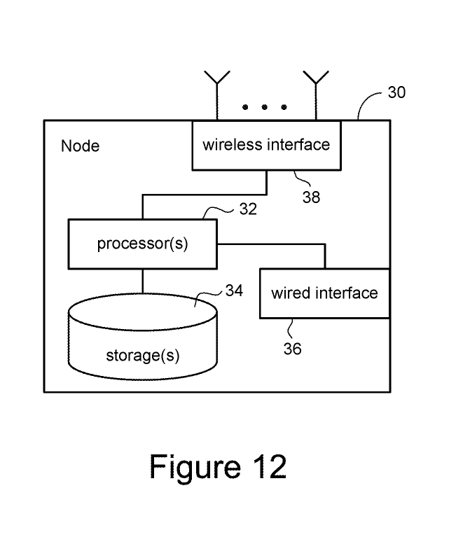

Machine platforms for an RNC, a base station, and a UE may take any of several forms, such as (for example) electronic circuitry in the form of a computer implementation platform or a hardware circuit platform. FIG. 12 is a function block diagram of a suitable example computer implementation of the machine platform 30 realized by or implemented as one or more computer processors or controllers as those terms are expansively defined, and which may execute instructions stored on non-transitory computer-readable storage media. In such a computer implementation, a machine platform may comprise, in addition to a processor(s) 32, a memory section 34 (which in turn can comprise random access memory, read only memory, an application memory (a non-transitory computer-readable medium which stores, e.g., coded non instructions which can be executed by the processor(s) 32 to perform acts described herein), and any other memory such as cache memory, for example). A wired interface is shown that may be used in the RNC and base station, while a wireless interface 38 is shown that may be used in the base station and UE. Another example platform suitable is that of a hardware circuit, e.g., an application specific integrated circuit (ASIC), a digital signal processor (DSP), a programmable gate array (PGA), etc., where circuit elements are structured and operated to perform the various acts described herein.

The technology described here includes many advantages. For example, introducing common control channel orders, e.g., HS-SCCH orders, gives the base station, e.g., NodeB, the ability to address all or a group of UEs with a single HS-SCCH order transmission. This is in contrast to a NodeB having to send a separate, dedicated HS-SCCH order to each UE. Other advantages include reduced downlink control signaling overhead (since fewer orders need to be sent), reduced downlink interference (since fewer orders need to be sent), and lower downlink latency for both HS-SCCH orders and HSDPA data since the average queuing time in the HSDPA scheduler can be reduced when fewer order need to be transmitted. The technology also allows re-use of existing specifications and existing implementations (of HS-SCCH order handling). Common HS-SCCH orders also share the benefits of ordinary (UE-specific) HS-SCCH orders, e.g., low false alarm rate (compared to e.g. E-AGCH) and low latency (compared to e.g. RRC signaling).

Although the description above contains many specifics, they should not be construed as limiting but as merely providing illustrations of some presently preferred embodiments. Embodiments described herein may be considered as independent embodiments or may be considered in any combination with each other to describe non-limiting examples. Although non-limiting, example embodiments of the technology were described in a UTRAN HSPA context, the principles of the technology described may also be applied to other radio access technologies.

Indeed, the technology fully encompasses other embodiments which may become apparent to those skilled in the art. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for a device or method to address each and every problem sought to be solved by the described technology for it to be encompassed hereby.

### ABBREVIATIONS

3GPP Third Generation Partnership Project
ACK (Positive) Acknowledgement
ARQ Automatic Repeat Request
DC-HSUPA Dual-Cell HSUPA
DPCCH Downlink Physical Control Channel
DTX Discontinuous Transmission
E-AGCH E-DCH Absolute Grant Channel
E-DCH Enhanced Dedicated Channel
E-DPCCH E-DCH Dedicated Physical Control Channel
E-DPDCH E-DCH Dedicated Physical Data Channel
E-HICH E-DCH HARQ Acknowledgement Indicator Channel
E-RGCH E-DCH Relative Grant Channel
E-TFC E-DCH Transmission Format Combination
F-DPCH Fractional Dedication Control Channel
EUL Enhanced Uplink (=HSUPA)
HARQ Hybrid ARQ
H-RNTI HS-DSCH Radio Network Transaction Identifier
HSDPA High Speed Downlink Packet Access
HS-DSCH High Speed Downlink Shared Channel
HS-DPCCH Dedicated Physical Control Channel for HS-DSCH
HSPA High Speed Packet Access
HS-SCCH Shared Control Channel for HS-DSCH
HSUP High Speed Uplink Packet Access
MC-HSUPA Multi-Carrier HSUPA
MIMO Multiple Input Multiple Output
NACK Negative Acknowledgement
RLC Radio Link Control
RNC Radio Network Controller
RRC Radio Resource Control
SHO Soft Handover
SIR Signal to Interference (plus noise) ratio
TPC Transmit Power Control
TTI Transmission Time Interval
UE User Equipment
UL Uplink
WCDMA Wideband Code Division Multiple Access

1. A method implemented in a radio base station communicating with user equipments (UEs) over a radio interface on a shared control channel in a cell coverage area, comprising:
determining a common control channel order for transmission over the shared control channel for a group of multiple UEs in the cell;
processing the common control channel order to associate the common control channel order with a common control channel order identifier; and
transmitting the processed common control channel order in the cell over the shared control channel.

2. The method in claim 1, wherein the processing includes masking the common control channel order to associate the common control channel order with the common control channel order identifier.

3. The method in claim 1, further comprising:
monitoring for common control channel order acknowledgment messages (ACKs) from the UEs in the group, and
when an ACK is not received from one of the UEs in the group, re-transmitting the processed common control channel order using a dedicated control channel order that includes a UE-specific identifier assigned to the one UE that is not assigned to the other UEs in the group.

4. The method in claim 1, further comprising:
monitoring for common control channel order acknowledgment messages (ACKs) from the UEs in the group,
when an ACK is not received from one of the UEs in the group, determining if a total number of ACKs received from UEs in the group is less than a threshold,
if so, retransmitting the processed common control channel order, and
if not, transmitting the common control channel order using a dedicated control channel order that includes a UE-specific identifier assigned to the one UE that is not assigned to the other UEs in the group.

5. The method in claim 1, further comprising:
determining a dedicated, UE-specific control channel order for the shared control channel for one or more of the UEs that is different from the common control channel order;
processing the dedicated, UE-specific control channel order to associate the dedicated, UE-specific control channel order with a corresponding dedicated, UE-specific control channel order identifier; and
transmitting the processed dedicated, UE-specific control channel order in the cell.

6. The method in claim 5, wherein:
the base station and UEs are part of a high speed packet access (HSPA) cellular communications system that includes a radio network controller (RNC) communicating with the base station,
the shared control channel is a high speed shared control channel (HS-SCCH),
the common control channel order identifier is a common high speed downlink shared channel (HS-DSCH) Radio Network Identifier (H-RNTI), and
the dedicated, UE-specific control channel order identifier is a dedicated, UE-specific H-RNTI,
the method further comprising:
receiving from the RNC a common H-RNTI and a dedicated, UE-specific H-RNTI for each UE in the group, where each respective dedicated, UE-specific H-RNTI is different;
sending the common H-RNTI to the group of UEs;
sending each dedicated, UE-specific H-RNTI to each respective UE.

7. A method implemented in a user equipment (UE) communicating with a radio base station over a radio interface on a shared control channel in a cell coverage area that is shared by multiple UEs, comprising:
receiving a common control channel order signal transmitted by the base station in the cell to a group of multiple UEs over the shared control channel;
detecting a common control channel signal identifier associated with the common control channel order signal;
determining that common control channel signal identifier matches a common control channel signal identifier previously configured for or stored in each of the UEs in the group; and
performing one or more actions in response to the common control channel order.

8. The method in claim 7, wherein the determining includes masking the common control channel order with the common control channel order identifier.

9. The method in claim 8, further comprising transmitting a common control channel order acknowledgment message (ACK) to the base station.

10. The method in claim 7, further comprising:
receiving a dedicated control channel order signal specific to the UE transmitted by the base station in the cell over the shared control channel;
detecting a dedicated control channel signal identifier specific to the UE associated with the dedicated, UE-specific control channel order signal; and
performing one or more actions in response to the processed, dedicated, UE-specific control channel order.

11. The method in claim 10, wherein:
the base station and UE are part of a high speed packet access (HSPA) cellular communications system that includes a radio network controller (RNC) communicating with the base station,
the shared control channel is a high speed shared control channel (HS-SCCH),
the common control channel order identifier is a common high speed downlink shared channel (HS-DSCH) Radio Network Identifier (H-RNTI), and
the dedicated, UE-specific control channel order identifier is a dedicated, UE-specific H-RNTI,
the method further comprising:
receiving from the RNC via the base station a common H-RNTI and a dedicated, UE-specific H-RNTI.

12. A method implemented in a radio network controller (RNC) in communication with a base station, the base station communicating with user equipments (UEs) over a radio interface on a shared control channel in a cell coverage area, comprising:
generating a common control channel order identifier for use by the base station in transmitting a common control channel order over the shared control channel to a group of multiple UEs in the cell, and
sending the common control channel order identifier to the base station so that the base station can send the common control channel order identifier to each of the UEs in the group.

13. The method in claim 12, further comprising:
generating a dedicated, UE-specific control channel identifier for the shared control channel each of one or more of the UEs in the group, wherein each dedicated, UE-specific control channel identifier is different from the other dedicated, UE-specific control channel identifiers and from the common control channel identifier, and
sending the dedicated, UE-specific control channel identifiers to the base station for use by the base station and distribution by the base station to corresponding UEs in the group.

14. The method in claim 13, wherein:
the RNC, base station, and UEs are part of a high speed packet access (HSPA) cellular communications system,
the shared control channel is a high speed shared control channel (HS-SCCH),
the common control channel order identifier is a common high speed downlink shared channel (HS-DSCH) Radio Network Identifier (H-RNTI), and
the dedicated, UE-specific control channel order identifier is a dedicated, UE-specific H-RNTI.

15. A radio base station that communicates with user equipments (UEs) over a radio interface on a shared control channel in a cell coverage area, the radio base station comprising:
data processing circuitry configured to:
determine a common control channel order for transmission over the shared control channel for a group of multiple UEs in the cell, and
process the common control channel order to associate the common control channel order with a common control channel order identifier; and
radio circuitry configured to transmit the processed common control channel order in the cell over the shared control channel.

16. The radio base station in claim 15, wherein the data processing circuitry is configured to mask the common control channel order to associate the common control channel order with the common control channel order identifier.

17. The radio base station in claim 15, wherein the data processing circuitry is configured to monitor for common control channel order acknowledgment messages (ACKs) from the UEs in the group, and
when an ACK is not received from one of the UEs in the group, the radio circuitry is configured to retransmit the processed common control channel order using a dedicated control channel order that includes a UE-specific identifier assigned to the one UE that is not assigned to the other UEs in the group.

18. The radio base station in claim 15, wherein the data processing circuitry is configured to:
monitor for common control channel order acknowledgment messages (ACKs) from the UEs in the group, and
when an ACK is not received from one of the UEs in the group, determine if a total number of ACKs received from UEs in the group is less than a threshold,
wherein if the total number of ACKs received from UEs in the group is less than the threshold, the radio circuitry is configured to retransmit the processed common control channel order, and
wherein if the total number of ACKs received from UEs in the group is not less than the threshold, the radio circuitry is configured to transmit the common control channel order using a dedicated control channel order that includes a UE-specific identifier assigned to the one UE that is not assigned to the other UEs in the group.

19. The radio base station in claim 15, wherein the data processing circuitry is configured to:
determine a dedicated, UE-specific control channel order for the shared control channel for one or more of the UEs that is different from the common control channel order;
process the dedicated, UE-specific control channel order to associate the dedicated, UE-specific control channel order with a corresponding dedicated, UE-specific control channel order identifier; and
wherein the radio circuitry is configured to transmit the processed dedicated, UE-specific control channel order in the cell.

20. The radio base station in claim 19, wherein:
the base station and UEs are part of a high speed packet access (HSPA) cellular communications system that includes a radio network controller (RNC) communicating with the base station,
the shared control channel is a high speed shared control channel (HS-SCCH),
the common control channel order identifier is a common high speed downlink shared channel (HS-DSCH) Radio Network Identifier (H-RNTI), and
the dedicated, UE-specific control channel order identifier is a dedicated, UE-specific H-RNTI.

21. The radio base station in claim 20, wherein the radio circuitry is configured to:
receive from the RNC a common H-RNTI and a dedicated, UE-specific H-RNTI for each UE in the group, where each respective dedicated, UE-specific H-RNTI is different;
send the common H-RNTI to the group of UEs; and
send each dedicated, UE-specific H-RNTI to each respective UE.

22. A user equipment (UE) for communicating with a radio base station over a radio interface on a shared control channel in a cell coverage area that is shared by multiple UEs, the UE comprising:
a receiver configured to receive a common control channel order signal transmitted by the base station in the cell to a group of multiple UEs over the shared control channel;
a data processor configured to:
detect a common control channel signal identifier associated with the common control channel order signal;
determine that common control channel signal identifier matches a common control channel signal identifier previously configured for or stored in each of the UEs in the group; and
perform one or more actions in response to the processed common control channel order.

23. The UE in claim 22, wherein the data processor is configured to mask the common control channel order with the common control channel order identifier.

24. The UE in claim 22, further comprising a transmitter configured to transmit a common control channel order acknowledgment message (ACK) to the base station.

25. The UE in claim 22, wherein the receiver is further configured to receive a dedicated control channel order signal specific to the UE transmitted by the base station in the cell over the shared control channel,
wherein the data processor is configured to:
detect a dedicated control channel signal identifier specific to the UE associated with the dedicated, UE-specific control channel order signal, and
perform one or more actions in response to the processed, dedicated, UE-specific control channel order.

26. The UE in claim 25, wherein:
the base station and UE are part of a high speed packet access (HSPA) cellular communications system that includes a radio network controller (RNC) communicating with the base station,
the shared control channel is a high speed shared control channel (HS-SCCH),
the common control channel order identifier is a common high speed downlink shared channel (HS-DSCH) Radio Network Identifier (H-RNTI), the dedicated, UE-specific control channel order identifier is a dedicated, UE-specific H-RNTI, and
the receiver is configured to receive from the RNC via the base station a common H-RNTI and a dedicated, UE-specific H-RNTI.

27. A radio network controller (RNC) in communication with a base station, the base station communicating with user equipments (UEs) over a radio interface on a shared control channel in a cell coverage area, the RNC comprising data processing circuitry configured to:
generate a common control channel order identifier for use by the base station in transmitting a common control channel order over the shared control channel to a group of multiple UEs in the cell, and
send the common control channel order identifier to the base station so that the base station can send the common control channel order identifier to each of the UEs in the group.

28. The RNC in claim 27, wherein the data processing circuitry is configured to:
generate a dedicated, UE-specific control channel identifier for the shared control channel each of one or more of the UEs in the group, wherein each dedicated, UE-specific control channel identifier is different from the other dedicated, UE-specific control channel identifiers and from the common control channel identifier, and
send the dedicated, UE-specific control channel identifiers to the base station for use by the base station and distribution by the base station to corresponding UEs in the group.

29. The RNC in claim 28, wherein:
the RNC, base station, and UEs are part of a high speed packet access (HSPA) cellular communications system,
the shared control channel is a high speed shared control channel (HS-SCCH),
the common control channel order identifier is a common high speed downlink shared channel (HS-DSCH) Radio Network Identifier (H-RNTI), and
the dedicated, UE-specific control channel order identifier is a dedicated, UE-specific H-RNTI.
